(19) United States
(12) Patent Application Publication
(10) Pub. No.: US 2009/0185670 A1
(43) Pub. Date: Jul. 23, 2009

(54) Method and Apparatus for Using a User Message From a Caller Terminal as a Call Alert For a Callee Terminal

(76) Inventor: Jeremy P. Staples, Simi Valley, CA (US)

Correspondence Address: WALL & TONG, LLP/;ALCATEL-LUCENT USA INC., 595 SHREWSBURY AVENUE, SHREWSBURY, NJ, 07702, US

(21) Appl. No.: 12/018,289

(22) Filed: Jan. 23, 2008

(51) Int. Cl. H04M 3/00

(52) U.S. Cl. 379/252

(57) ABSTRACT

The invention includes a method and apparatus for using a user message from a caller terminal as a call alert for a callee terminal. In one embodiment, a method for providing a user message from a caller terminal as a call alert includes detecting a request at the caller terminal to establish a connection, receiving a user message at the caller terminal and propagating the user message from the caller terminal toward the callee terminal, wherein the user message is adapted for use as a call alert to the callee terminal. In one embodiment, a method for using a user message as a call alert includes receiving, at a callee terminal, a user message associated with a connection establishment request and presenting the user message as a call alert for the connection establishment request.

### FIELD OF THE INVENTION

The invention relates to the field of communication networks and, more specifically, to alerting a callee to an incoming call.

### BACKGROUND OF THE INVENTION

In existing wireless networks, when a caller places a call to a callee, the callee is alerted to the incoming call from the caller using a ringtone which is typically a standard ringing sound or a song clip. There is a continuing need for advancements in the field of call alerting.

### SUMMARY OF THE INVENTION

These needs are addressed through various methods for using a user message from a caller terminal as a call alert for a callee terminal.

In one embodiment, a method for providing a user message from a caller terminal as a call alert includes detecting a request at the caller terminal to establish a connection, receiving a user message at the caller terminal and propagating the user message from the caller terminal toward the callee terminal, wherein the user message is adapted for use as a call alert to the callee terminal.

In one embodiment, a method for using a user message as a call alert includes receiving, at a callee terminal, a user message associated with a connection establishment request and presenting the user message as a call alert for the connection establishment request.

In one embodiment, a method for providing a user message as a call alert includes receiving a connection establishment request having associated therewith a user message adapted for use as a call alert to a callee terminal, determining whether the callee terminal is registered for a user message alerting service, and propagating the user message toward the callee terminal in response to a determination that the callee terminal is registered for the user message alerting service.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a communication network;

FIG. 2 depicts a method according to one embodiment of the present invention;

FIG. 3 depicts a method according to one embodiment of the present invention;

FIG. 4 depicts a method according to one embodiment of the present invention; and

FIG. 5 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention enables a wireless caller terminal to provide a message to a wireless callee terminal for use by the wireless callee terminal as a call alert for alerting the callee of the incoming call (i.e., the provided message is played as an alternative to a ringtone). The user message (which may also be referred to herein as a preamble) may be a voice message, a video message, and the like. Thus, the present invention enables the caller to convey information to the callee about the incoming call using the user message (e.g., the identity of the caller, the importance of the call, and the like, as well as various combinations thereof).

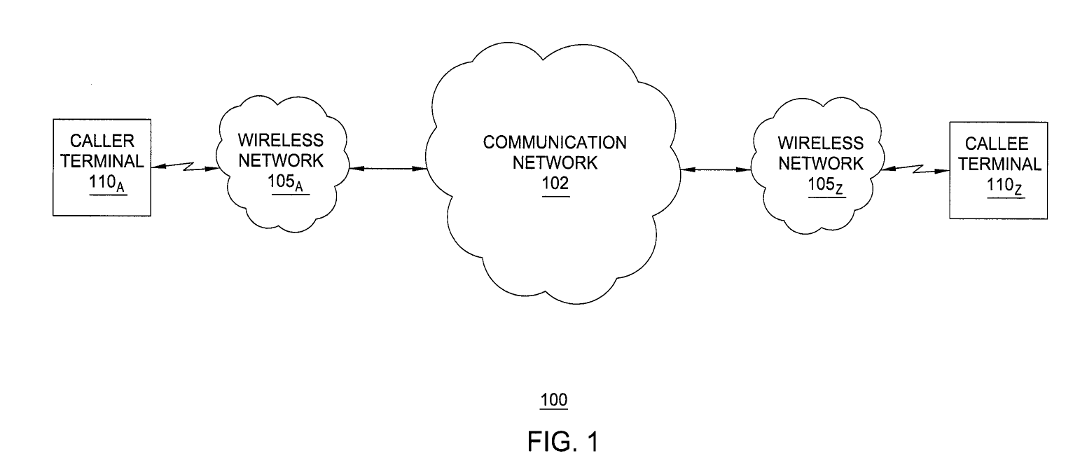

FIG. 1 depicts a high-level block diagram of a communication network. Specifically, communication network 100 includes a communication network 102 adapted for supporting communications between a caller terminal 110_{A} and a callee terminal 110_{Z} (collectively, terminals 110). As depicted in FIG. 1, in one embodiment, terminals 110 are mobile terminals supporting wireless communications. The caller terminal 110_{A} and callee terminal 110_{Z} access communication network 102 via respective wireless networks 105_{A} and 105_{Z} (collectively, wireless networks 105).

The communication network 100 may be implemented using any communications technologies. For example, communication network 102 may include any network adapted for facilitating communications between access networks (illustratively, between wireless networks 105). In one embodiment, for example, communication network 102 is a packet-based communication network. For example, wireless networks 105 may include wireless networks such as Universal Mobile Telecommunications System (UMTS) networks, Code Division Multiple Access 2000 (CDMA2000) networks, and the like, as well as various combinations thereof.

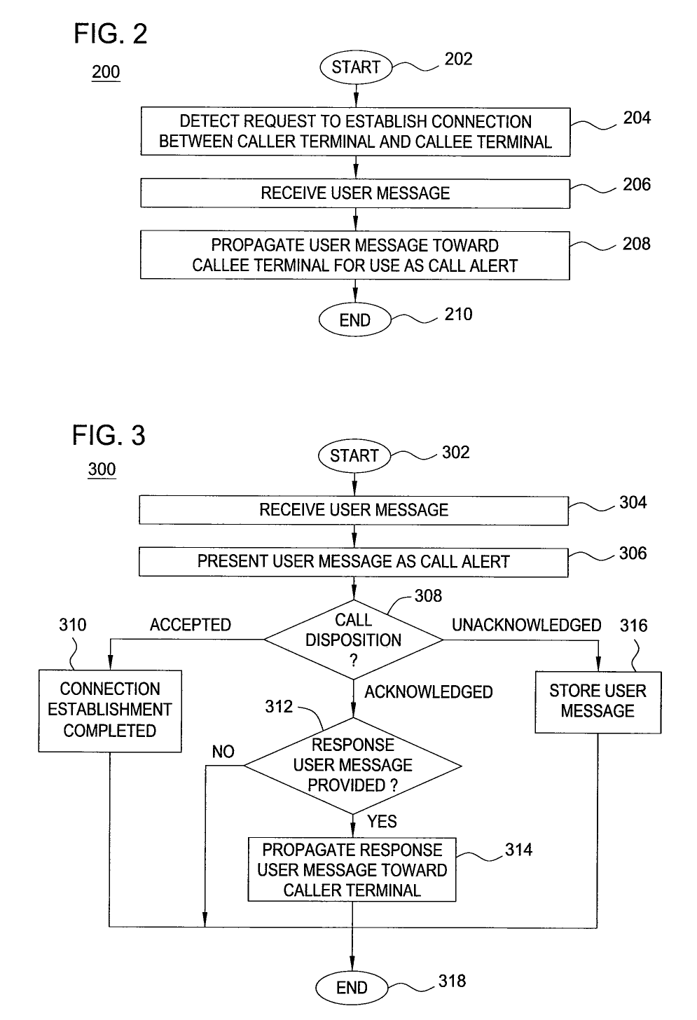

FIG. 2 depicts a method according to one embodiment of the present invention. Specifically, method 200 of FIG. 2 includes a method for providing a user message from a caller terminal toward a callee terminal for use by the callee terminal as a call alert. Although depicted and described as being performed serially, at least a portion of the steps of method 200 of FIG. 2 may be performed contemporaneously, or in a different order than depicted and described with respect to FIG. 2. The method 200 begins at step 202 and proceeds to step 204.

At step 204, a request to establish a connection with a callee terminal is detected. The request to establish the connection with the callee terminal is detected by the caller terminal. The detected request to establish the connection with the callee terminal is a request to establish a connection with the callee terminal using the user message alerting service. The caller terminal may detect a request to establish a connection with a caller terminal in any manner. Similarly, the caller may initiate a request to establish a connection with a callee terminal in any manner.

In one embodiment, for example, the caller accesses a phonebook, selects a callee to which to place the call, and initiates a call to the selected callee. In another embodiment, for example, the caller uses speech-based control in order to select a callee and initiate a call to the selected callee. The caller may initiate the request to establish the connection with the callee terminal in any other manner. The caller may perform such actions in any manner (e.g., using one or more button presses, voice-based control functions, or any other user interaction means by which the caller may select a callee and initiate a request to establish a connection with the associated callee terminal).

In one embodiment, the caller may be provided a separate means by which to initiate a standard call (i.e., a call that does not use the user message alerting service) versus a non-standard call (i.e., a call that uses the user message alerting service). For example, the caller terminal may include a first call initiation means for initiating standard calls (e.g., the existing call initiate button on most mobile phones, one or more voice commands, and the like) and a second call initiation means for initiating non-standard calls (e.g., a new button on mobile phones (or reuse of one or more existing buttons), one or more new voice commands, and the like). The caller may initiate a call using the user message alerting service via any means of interacting with a user interface of the caller terminal (e.g., buttons, touch screen, voice, and the like).

In one embodiment, the phonebook may provide an indication as to whether or not a callee subscribes to the user message alerting service (and, thus, whether or not the caller should even attempt to initiate a call using the user message alerting service). In one further embodiment, where the phonebook provides an indication as to whether or not a callee subscribes to the user message alerting service, the phonebook may also provide an associated indication as to whether or not the user message alerting service is currently active for the callee (and, thus, whether or not the caller should even attempt to initiate a call using the user message alerting service). In such embodiments, the indication(s) may be provided in any manner (e.g., using icons, text, or any other similar means for indicating such information).

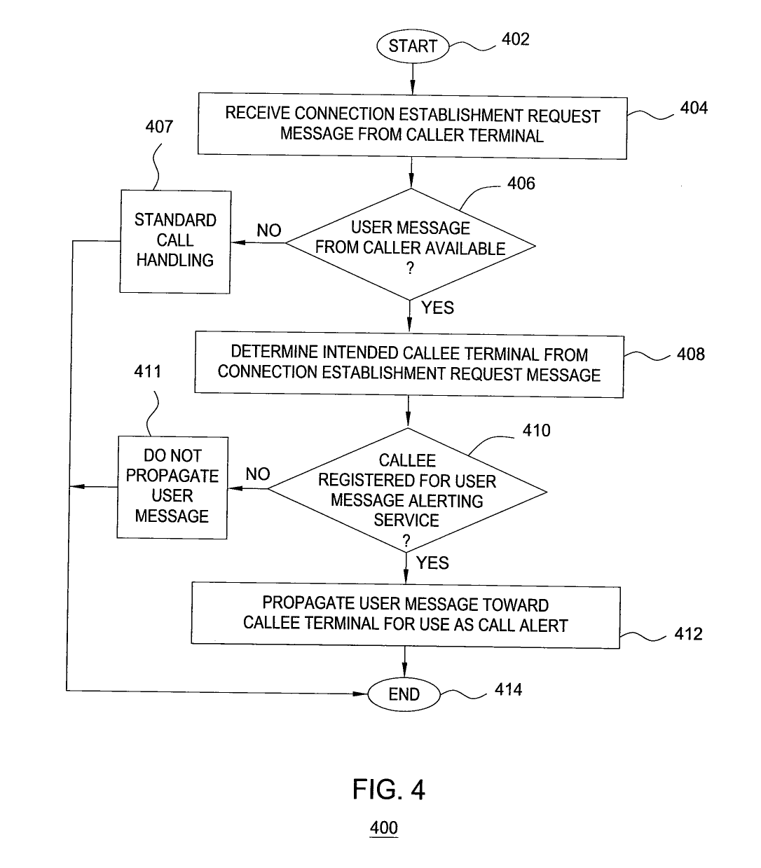

In one embodiment, in which an intended callee is not registered for the user message alerting service, the caller terminal may prevent the caller from attempting to initiate a call to the callee using the user message alerting service. In another embodiment, the caller terminal may allow the caller to initiate a call to the callee using the user message alerting service irrespective of service subscription information. In one such embodiment, the network may include connection establishment handling capabilities adapted for controlling whether or not the callee terminal receives a user message from the caller terminal for use by the callee terminal as a call alert. A method according to one such embodiment is depicted and described with respect to FIG. 4.

At step 206, a user message is received. The user message is adapted for being used by the callee terminal as a call alert in order to alert the callee of the incoming call (i.e., to be used as an alternative to a ringtone, such as standard ringing and song clips). The user message may be any type of user message which may be provided by the caller. For example, the user message may be a text message (e.g., which may be coupled with some other type of call alert, such as a standard ringtone, vibration, a voice and/or video message in accordance with the present invention, and the like), a voice message, a video message, a multimedia message, and the like, as well as various combinations thereof.

The user message to be used as the call alert at the callee terminal may be received at the caller terminal in any manner.

In one embodiment, for example, in response to detection of the request to establish the connection with the callee terminal, the caller terminal may prompt the caller to enter a user message to use as the call alert. In this embodiment, entry of the user message may depend on the type of information to be included in the user message. For example, for a user message including text, the user may be prompted to type a message. For example, for a user message including voice, the user may be prompted to record a voice message. For example, for a user message including video, the user may be prompted to record a video clip.

In another embodiment, for example, in response to detection of the request to establish the connection with the callee terminal, the caller terminal may prompt the caller to select a preset user message to use as the call alert. In this embodiment, one or more pre-saved messages (e.g., pre-saved text, prerecorded voice, prerecorded video, and the like, as well as various combinations thereof) may be retrieved from local memory of the caller terminal and presented to the caller for selection of the user message to be sent to the callee terminal for use as the call alert.

The user message to be used as the call alert may be received in any other manner.

In one embodiment, in which the user message includes text, the amount of text included in the user message may be limited (e.g., to a certain number of characters, certain types of characters, and the like, depending on various conditions, such as network capacity and the like.

In one embodiment, in which the user message includes voice, the maximum duration of the voice message may be limited (e.g., to 3 seconds, 5 seconds, 10 seconds, or any other length of time, depending on various conditions, such as network capacity and the like).

In one embodiment, in which the user message includes video, the maximum duration of the video message may be limited (e.g., to 2 seconds, 4 seconds, 7 seconds, or any other length of time, depending on various conditions, such as network capacity and the like).

The user message enables the caller to convey information to the callee (i.e., information that could not otherwise be conveyed using ringtones). For example, the user message may be used to indicate the identity of the caller, the importance of the call, the availability of the caller, the location of the caller, or any other information which may be conveyed by the caller using the resources allotted for the user message.

As an example, the user message may be: “Jim. I have great news. Answer your phone.” As another example, the user message may be: “Bob. My car broke down. Please pick up.” As another example, the voice message may be “Sue. It's an emergency. I need to talk to you right away.” In other words, the caller may provide virtually any user message for use as a call alert, thereby enabling the caller to provide information to the callee as part of the call alert.

At step 208, the user message is propagated from the caller terminal toward the callee terminal. The user message may be propagated toward the callee terminal in any manner. For example, the user message may be propagated toward the caller terminal using any communication network(s), communication protocol(s), messaging/signaling scheme(s), and the like, as well as various combinations thereof.

The user message may be propagated toward the callee terminal using any communications technology. In one embodiment, for example, the user message may be propagated toward the callee terminal using packets (e.g., by encoding and packetizing the user message for transmission over packet communication networks). In another embodiment, for example, the user message may be propagated toward the callee terminal using radio transmission capabilities (e.g., similar to radio-based transmissions in walkie-talkie-type wireless communication networks). The user message may be propagated from the caller terminal toward the callee terminal using any other communication technologies.

The user message may be propagated toward the callee terminal using any messaging/signaling scheme. In one embodiment, for example, the user message is propagated as part of a connection establishment request message propagated from the caller terminal to the callee terminal. In another embodiment, for example, the user message is propagated as a separate message (e.g., one that is separate from, but associated with, a connection establishment request message propagated from the caller terminal toward the callee terminal). The user message may be propagated from the caller terminal toward the callee terminal using any other messaging/signaling schemes.

At step 210, method 200 ends. Although depicted and described as ending (for purposes of clarity), the overall process by which a user message from the caller terminal may be used as a call alert by the caller terminal continues with processing performed by the callee terminal in response to receiving a request to establish a connection which has an associated user message for use by the callee terminal as a call alert. The processing that is performed by the callee terminal in response to receiving a user message intended for use by the callee terminal as a call alert is depicted and described with respect to FIG. 3.

FIG. 3 depicts a method according to one embodiment of the present invention. Specifically, method 300 of FIG. 3 includes a method for presenting a user message as a call alert for an incoming call from a caller terminal to a callee terminal. Although depicted and described as being performed serially, at least a portion of the steps of method 300 of FIG. 3 may be performed contemporaneously, or in a different order than depicted and described with respect to FIG. 3. The method 300 begins at step 302 and proceeds to step 304.

At step 304, a user message is received. The user message is received at the callee terminal. The user message is initiated from a caller terminal and propagated to the callee terminal via a communication network (e.g., via a cellular communication network). As described herein (with respect to FIG. 2), the user message may be propagated from the caller terminal to the callee terminal in any manner and, therefore, the user message may be received at the callee terminal in any manner (e.g., as a portion of or separate from a connection establishment request message, using any communication protocol(s), and the like).

At step 306, the user message is presented as the call alert for the incoming call from the caller terminal to the callee terminal. The user message may be presented in any manner (which may depend on the information of which the user message is composed).

In one embodiment, in which the user message includes text, the text may be displayed on one or more display interfaces of the callee terminal. The text may be displayed in any manner (e.g., permanently for the duration of the call alert, scrolling for the duration of the call alert, and the like).

In one embodiment, in which the user message includes voice, the voice message may be played from the speaker(s) of the callee terminal. In one embodiment, the voice message is only played once as the call alert. In another embodiment, the voice message may be played multiple times as the call alert (where the number of times the voice message is played may depend on factors such as the duration of the voice message, the duration of the call alert set for the callee terminal, and the like, as well as various combinations thereof.

In one embodiment, in which the user message includes video, the video message may be played on one or more display interfaces of the callee terminal. In one embodiment, the video message is only played once as the call alert. In another embodiment, the video message may be played multiple times as the call alert (where the number of times the video message is played may depend on factors such as the duration of the video message, the duration of the call alert set for the callee terminal, and the like, as well as various combinations thereof.

In one embodiment, in which the user message is propagated to the callee terminal as part of a connection establishment request message, the callee terminal receives the connection establishment request message, extracts the user message from the connection establishment request message, and presents the user message as the call alert for the incoming call in order to alert the callee to the incoming call from the caller terminal. In one such embodiment, the callee terminal may also perform a step of determining whether or not a connection establishment request message includes a user message (for determining whether or not the incoming call is using the user message alerting service).

In one embodiment, in which the user message is propagated to the callee terminal as a message that is separate from, but associated with, a connection establishment request message, the callee terminal receives the user message and presents the user message as the call alert for the incoming call in order to alert the callee to the incoming call from the caller terminal. In one such embodiment, the user message may be received as a stream of packets, in which case the callee terminal recovers the user message from the stream of packets (e.g., by depacketizing and decoding the user message).

At step 308, a determination is made regarding the disposition of the call at the callee terminal. In one embodiment, for example, a determination is made as to whether the incoming call is accepted (e.g., the callee answers the call), acknowledged (e.g., the callee does not answer the call, but does acknowledge the user message presented as the call alert), or unacknowledged (e.g., the callee does not answer or acknowledge the call) at the callee terminal.

If the incoming call is accepted, method 300 proceeds to step 310, at which point connection establishment is completed and the caller and callee can communicate using the established connection. From step 310, method 300 proceeds to step 318, where method 300 ends.

If the incoming call is acknowledged, method 300 proceeds to step 312, at which point a determination is made as to whether or not the callee wishes to provide a response user message to the caller. If the callee does not wish to provide a response user message to the caller, method 300 proceeds to step 318, where method 300 ends. If the callee does wish to provide a response user message, method 300 proceeds to step 314.

At step 314, the callee provides a response user message to the caller. In one embodiment, the callee may provide the response user message to the caller in a manner similar to the manner in which the caller initiates a call using the user message alerting service. For example, in response to a call alert presented by the callee terminal, the callee may enter a response user message that is then propagated from the callee terminal back to the caller terminal (without establishment of the requested connection between the caller terminal and the callee terminal).

In one embodiment in which the callee acknowledges the user message from the caller, the callee may opt not to reject the incoming call from the caller (such that user messaging between the callee and the caller may continue while the callee still has an option to answer the call and complete the connection at any time during such messaging). In another embodiment in which the callee acknowledges the user message from the caller, the callee may reject the incoming call from the caller (although user messaging between the callee and caller may continue).

As an example, if a callee receives a call alert such as “Jim. It's urgent. Please pick up.”, the callee may elect to acknowledge the user message by providing a response user message back to the caller, such as “I'm with a client. I will call you back in five minutes.”

As another example, if a callee receives a call alert such as “Sue. I need your help with something.”, the callee may elect to explicitly reject the call (such that the connection between the caller terminal and callee terminal cannot be established at that time) and provide a response user message back to the caller, such as “I'm in the shower. I will call you back.”

In other words, the callee may provide virtually any message for use as a response to the call request received from the caller.

In one embodiment, the response user messaging capability may be used by the callee independent of whether or not the caller initiated the call to the callee using the user message alerting service (e.g., even in response to a standard call from the caller that does not use a user message from the caller as a call alert). In another embodiment, the response user messaging capability may be used by the callee only if the caller initiated the call to the callee using the user message alerting service.

In one further embodiment, in response to receiving a response user message from a callee (which is presented on the caller terminal), the caller may then record another user message which is then propagated to the callee terminal. This exchange of user messages may continue back and forth for as long as desired, thereby delaying establishment of the connection between the caller and callee (or even without the connection establishment between the caller terminal and the callee terminal ever being completed). In this manner, the caller and callee may communicate over connection-oriented networks (e.g., cellular networks and the like) in a manner similar to walkie-talkie communications.

From step 314, method 300 proceeds to step 318, where method 300 ends.

If the incoming call is unacknowledged (and, therefore, unanswered), method 300 proceeds to step 316, at which point the callee terminal stores the user message. In one embodiment, the user message is stored locally on the callee terminal such that the user message is easily and quickly retrievable (i.e., without having to connect to the network to obtain the user message). In another embodiment, the user message may be stored in the network. From step 316, method 300 proceeds to step 318, where method 300 ends.

From each of steps 310, 312 (where no response user message is sent), 314, and 316, method 300 proceeds to step 318, where method 300 ends. Although depicted and described as ending (for purposes of clarity), any other call handling functions may be performed (e.g., directing the caller to leave a voicemail where the incoming call is not accepted or acknowledged, using call forwarding features where the incoming call is not accepted or acknowledged, and the like, as well as various combinations thereof).

As described herein, capabilities may be provided to prevent (or at least to help prevent) a caller from initiating a call to a callee using the user message alerting service if the callee is not subscribed to the user message alerting service.

In one embodiment, the caller terminal may be adapted to prevent the caller from initiating a call to a callee using the user message alerting service if the callee is not subscribed to the user message alerting service (e.g., using some information available at the caller terminal regarding whether or not the callee is subscribed to the user message alerting service, using some information available at the caller terminal regarding whether or not the user message alerting service is currently active for the callee, and the like).

In another embodiment, the caller terminal is not adapted to prevent the caller from initiating a call to a callee using the user message alerting service if the callee is not subscribed to the user message alerting service. Rather, the caller terminal may simply display information which the caller may use to determine whether or not the callee is registered for the user message alerting service. In such embodiments, the caller will ultimately make the determination as to whether or not to use the user message alerting service to initiate the call to the callee.

Thus, where such capabilities ultimately depend on the caller to make the determination as to whether or not to initiate a call to a callee using the user message alerting service (e.g., using some information presented via the caller terminal, such as an icon or some other means of indicating service subscription/availability information), a simple oversight by the caller may result in the caller placing a call to the callee using the user message alerting service when the callee is not subscribed to the user message alerting service.

Unfortunately, the probability of such an occurrence may be increased during situations in which the user message alerting service is more likely to be used (e.g., during emergencies or times of excitement where the caller wants to indicate such urgency to the callee via a user message call alert, but does not carefully review the information that is made available to the caller for use in determining whether or not to place a call to the callee using the user message alerting service).

In one embodiment, in order to prevent this situation (which may occur through error or indifference of the caller), the network may include connection establishment handling capabilities adapted for controlling whether or not a call initiated to the callee using the user message alerting service is actually received by the callee according to the user message alerting service (i.e., whether or not the callee terminal receives a user message from the caller terminal for use by the callee terminal as a call alert). A method according to one such embodiment is depicted and described with respect to FIG. 4.

FIG. 4 depicts a method according to one embodiment of the present invention. Specifically, method 400 of FIG. 4 includes a method for controlling use of the user message alerting service based on subscription information. Although depicted and described as being performed serially, at least a portion of the steps of method 400 may be performed contemporaneously, or in a different order than depicted and described with respect to FIG. 4. The method 400 begins at step 402 and proceeds to step 404.

At step 404, a connection establishment request message is received from the caller terminal. The connection establishment request message is a request from the caller terminal to establish a connection with the callee terminal.

At step 406, a determination is made as to whether a user message is available from the caller.

In one embodiment, in which user messages are propagated as part of the connection establishment request messages, this determination may be made by determining whether or not the connection establishment request message includes a user message. In one embodiment, in which user messages are not propagated as part of the connection establishment request messages (e.g., but, rather, are sent as separate messages), this determination may be made by determining whether or not the connection establishment request message includes an indication that there is an associated user message.

If a user message from the caller is not available, method 400 proceeds to step 407, at which point standard call handling is applied (e.g., the connection establishment request message is propagated to the callee terminal, which alerts the callee to the incoming call using a ringtone, such as standard ringing or a song clip). From step 407, method 400 proceeds to step 414, where method 400 ends. If a user message from the caller is available, method 400 proceeds to step 408.

At step 408, the intended callee terminal is determined from the connection establishment request message. The intended callee terminal may be determined in any manner (which may vary according to the manner in which the connection establishment request is propagated from the caller terminal to the callee terminal. In one embodiment, for example, the intended callee terminal may be determined from one or more header fields of the connection establishment request message.

At step 410, a determination is made as to whether the intended callee is registered for the user message alerting service. The determination is made as to whether the intended callee is registered for the user message alerting service may be performed in any manner (e.g., using information stored locally on the network element, by querying one or more other network elements for service subscription information, and the like).

If the intended callee is not registered for the user message alerting service, method 400 proceeds to step 411, at which point a determination is made not to propagate the user message to the callee terminal.

In one embodiment, in which the user message was propagated as part of the connection establishment request message, the user message may be extracted from the connection establishment request message and the connection establishment request message may then be forwarded to the callee terminal.

In one embodiment, in which the user message was not propagated as part of the connection establishment request messages (e.g., but, rather, are sent as a separate message), the user message is not forwarded to the callee terminal.

In one embodiment, in which the user message from the caller is not forwarded to the callee terminal for use as the call alert, an indication may be propagated back to the caller terminal to inform the caller that the callee will not receive the user message. For example, a message may be propagated to the caller terminal as part of ringback signaling (e.g., “The person you are calling is unable to receive your message”, or any other message).

The use of a status message for informing the caller that the callee will not receive the user message ensures that the caller does not mistakenly believe that the callee has been informed of any information associated with the call (e.g., that the call is urgent, that the call is related to an emergency, and the like).

If the intended callee is registered for the user message alerting service, method 400 proceeds to step 412.

At step 412, the user message is propagated toward the callee terminal for use by the callee terminal as a call alert. The user message may be propagated toward the callee terminal in any manner.

At step 414, method 400 ends. Although depicted and described as ending (for purposes of clarity), at least some messaging is propagated toward the callee terminal (e.g., a connection establishment request message that does not include a user message, a connection establishment request message that does include a user message, and the like, as well as various combinations thereof.

Although primarily depicted and described herein within the context of a cellular communication network, the user message call alerting functions described herein may be implemented in other wireless communication networks. Although primarily depicted and described herein within the context of a cellular communication network, the user message call alerting functions described herein may be implemented in wireline communication networks. For example, the user message alerting service described herein may be implemented for voice calls between voice-over-IP (VoIP) phones or any other terminals adapted for use in entering user message for use as call alerts and presenting user messages as call alerts for incoming calls.

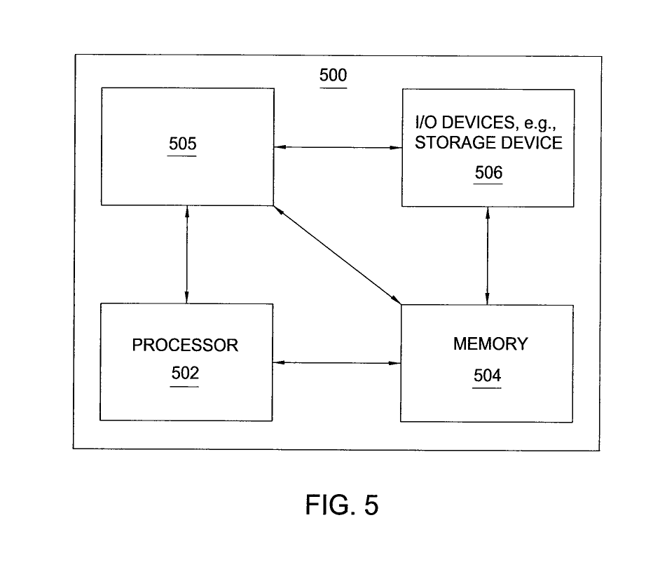

FIG. 5 depicts a high-level block diagram of a general-purpose computer suitable for use in performing the functions described herein. As depicted in FIG. 5, system 500 comprises a processor element 502 (e.g., a CPU), a memory 504, e.g., random access memory (RAM) and/or read only memory (ROM), a user message alerting module 505, and various input/output devices 506 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the functions/elements described herein may be implemented in software and/or in a combination of software and hardware, e.g., using application specific integrated circuits (ASIC), a general purpose computer or any other hardware equivalents. In one embodiment, the present user message alerting process 505 can be loaded into memory 504 and executed by processor 502 to implement the functions as discussed above. As such, user message alerting process 505 (including associated data structures) described herein can be stored on a computer readable medium or carrier, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for providing a user message from a caller terminal as a call alert, comprising:
detecting a request at the caller terminal to establish a connection;
receiving a user message at the caller terminal; and
propagating the user message from the caller terminal toward the callee terminal;
wherein the user message is adapted for use as a call alert to the callee terminal.

2. The method of claim 1, where the request to establish the connection comprises a request to establish a connection between the caller terminal and the callee terminal.

3. The method of claim 1, wherein receiving the user message at the caller terminal comprises:
prompting a caller to enter the user message; and
capturing the user message entered by the caller.

4. The method of claim 1, wherein the user message is received from a local memory of the caller terminal.

5. The method of claim 4, wherein the user message is received from the local memory of the caller terminal in response to selection of a pre-stored user message by a caller via the caller terminal.

6. The method of claim 1, wherein the user message is propagated toward the callee terminal as part of a connection establishment request message.

7. The method of claim 1, wherein the user message is propagated toward the callee terminal as a separate message independent of a connection establishment request message.

8. The method of claim 1, wherein propagating the user message comprises:
encoding the user message;
packetizing the encoded user message; and
propagating the packetized user message toward the callee terminal.

9. A method for using a user message as a call alert, comprising:
receiving a user message at a callee terminal, wherein the user message is associated with a connection establishment request; and
presenting the user message as a call alert for the connection establishment request.

10. The method of claim 9, wherein the user message is received as a portion of a connection establishment request message.

11. The method of claim 10, wherein presenting the user message as the call alert comprises:
determining that the connection establishment request message includes the user message; and
extracting the user message from the connection establishment request message.

12. The method of claim 9, wherein the user message is associated with a connection establishment request message.

13. The method of claim 12, wherein presenting the user message as the call alert comprises:
receiving the user message; and
decoding the received user message; and
presenting the decoded user message.

14. The method of claim 9, further comprising:
in response to a determination that the request to establish the connection is not accepted, storing the user message in a local memory of the callee terminal.

15. The method of claim 14, further comprising:
presenting the user message at the callee terminal in response to a request from the callee.

16. The method of claim 9, further comprising:
in response to a request from a callee via the callee terminal, prompting the callee to enter a response user message and propagating the response user message toward the caller terminal.

17. A method for providing a user message as a call alert, comprising:
receiving a connection establishment request having associated therewith a user message adapted for use as a call alert to a callee terminal;
determining whether the callee terminal is registered for a user message alerting service; and
propagating the user message toward the callee terminal in response to a determination that the callee terminal is registered for the user message alerting service.

18. The method of claim 17, wherein the user message is propagated toward the callee terminal as part of a connection establishment request message.

19. The method of claim 17, wherein the user message is propagated toward the callee terminal as a separate message independent of a connection establishment request message.

20. The method of claim 17, wherein determining whether the callee terminal is registered for the user message alerting service comprises:
retrieving service subscription information associated with the callee terminal; and
determining whether the callee terminal is registered for the user message alerting service using the service subscription information.
